(19) United States
(12) Patent Application Publication
(10) Pub. No.: US 2026/0313439 A1
(43) Pub. Date: Oct. 8, 2026

(54) WIRELESS COMMUNICATION METHOD AND DEVICE THEREOF

(71) Applicant: ZTE CORPORATION, Shenzhen, Guangdong (CN)

(72) Inventors: Jiajun XU, Shenzhen (CN); Bo DAI, Shenzhen (CN); Mengzhu CHEN, Shenzhen (CN); Jianqiang DAI, Shenzhen (CN); Jun XU, Shenzhen (CN)

(21) Appl. No.: 19/483,020

(22) PCT Filed: May 11, 2023
(86) PCT No.: PCT/CN2023/093545

§ 371 Date: Nov. 10, 2025

(51) Int. Cl. H04W 28/02; H04L 47/28

(52) U.S. Cl. CPC H04W 28/0268; H04L 47/28; H04W 28/0236

(57) ABSTRACT

A wireless communication method for use in a first node is disclosed. The method comprises receiving, from a second node, a configuration signaling which comprises a configuration information associated with synchronizing a plurality of data streams.

### CROSS-REFERENCE TO RELATED APPLICATION

The present disclosure is a national stage filing under 35 U.S.C. § 371 of international application number PCT/CN2023/093545, filed on May 11, 2023, which is incorporated herein by reference in its entirety.

### TECHNICAL FIELD

This document is directed generally to wireless communications, in particular to 5G communications and more particularly to 6G communications.

### BACKGROUND

In beyond 5G and 6G communications, Metaverse and multi-modality services are highly likely to be highly attractive applications which would challenge requirements of air interfaces. For these applications, one potential problem may be how to synchronize data among different devices or data for different literacies because there will be more and more devices and literacies for serving the same user.

This document relates to methods, systems, and devices for synchronizing data streams, and in particular to methods, systems, and devices for synchronizing data streams of devices required to be coordinated.

### SUMMARY

The present disclosure relates to a wireless communication method for use in a first node. The method comprises:
receiving, from a second node, a configuration signaling which comprises a configuration information associated with synchronizing a plurality of data streams.

Various embodiments may preferably implement the following features:

Preferably, the wireless communication method further comprises performing communications of the plurality of data streams based on the configuration information.

Preferably, synchronizing the plurality of data streams comprises at least one of:
processing the plurality of data streams synchronously,
scheduling the plurality of data streams synchronously, or
grouping a plurality of devices associated with the plurality of data streams.

Preferably, the configuration signaling is comprised in a general packet radio service (GPRS) transmission protocol packet, a GPRS transmission protocol (GTP) header, a quality of service (QoS) parameter set, a predefined radio bearer or a predefined protocol data unit (PDU) session.

Preferably, the configuration information comprises at least one of a device cluster indication for a plurality of devices associated with the plurality of data streams or a synchronization indication of synchronizing the plurality of data streams.

Preferably, the device cluster indication comprises at least one of:
a QoS parameter for the plurality of data streams,
device cluster information associated with a device cluster corresponding to the plurality of data streams, or the synchronization indication of synchronizing the plurality of data streams.

Preferably, the device cluster information comprises an association device identifier for a set of device identifiers of devices or a device cluster identifier.

Preferably, the synchronization indication is determined by a synchronization QoS parameter set, a synchronization QoS parameter, or a synchronization QoS flow.

Preferably, the synchronization QoS parameter set comprises at least one of: a minimum packet delay budget within packet delay budgets of the data streams, a maximum packet delay budget within the packet delay budgets of the data streams, an average packet delay budget of the packet delay budgets of the data streams, an offset for the packet delay budgets of the data streams, a reference packet delay budget within the packet delay budgets of the data streams, a time interval of synchronizing the plurality of data streams, a common packet delay budget for each data stream, or a synchronized level.

Preferably, the synchronization QoS parameter set comprises a set of QoS flow identifiers (QFIs).

Preferably, the wireless communication method further comprises synchronizing QoS flows corresponding to the QFIs in the synchronization QoS parameter set.

Preferably, performance characteristics of the data streams are determined based on the synchronization QoS parameter set.

Preferably, performance characteristics of each data stream is determined based on the synchronization QoS parameter set and a performance QoS parameter set, wherein the performance QoS parameter set comprises at least one of a resource type, a default priority level, a packet delay budget for transmission, a packet error rate for transmission, a default maximum data burst volume, or a default averaging window for communications of the data stream.

Preferably, the performance QoS parameter set is determined by a QFI filed in PDU session information.

Preferably, a determination of the synchronization QoS parameter set is based on a first field in PDU session information.

Preferably, an activation/deactivation of the synchronization QoS parameter set is determined based on a second field in PDU session information.

Preferably, the synchronization indication is determined by a radio bearer for the plurality of data streams.

Preferably, the radio bearer is a predefined radio bearer for the synchronization.

Preferably, the radio bearer includes at least one QoS flow of the data streams to be synchronized.

Preferably, the synchronization indication is determined by a PDU session which comprises at least one radio bearer comprising QoS flows of the data streams to be synchronized.

Preferably, the PDU session is determined by a GTP header of the PDU session.

Preferably, a GTP header of the PDU session indicates a synchronization PDU type.

Preferably, the synchronization indication is determined by a GTP header of the synchronization.

Preferably, the GTP header is a type of extension header.

Preferably, the type of extension header is determined by a next extension header type field value.

Preferably, the synchronization indication is determined by a PDU set importance indication for the plurality of data streams.

Preferably, the PDU set importance indication comprises at least one of: a PDU set importance level for the plurality of data streams, a synchronization request indication for synchronizing the plurality of data streams, or a QoS parameter set for synchronizing the plurality of data streams.

Preferably, the first node is a network node and the second node is a core network node.

Preferably, synchronizing the plurality of data streams comprises at least one of: jointly processing the plurality of data streams, jointly indicating the plurality of data streams or, transmitting, to the second node, assistance information associated with the synchronization.

Preferably, the configuration signaling comprises at least one of, a radio resource control signaling, a user equipment capability, a media access control (MAC) control element (CE) signaling, or a downlink control information signaling.

Preferably, the configuration information comprises a synchronization indication for the plurality of data streams.

Preferably, the synchronization indication comprises a predefined radio bearer.

Preferably, the wireless communication further comprises receiving, from the second node, an RRC signaling comprising a predefined radio bearer identifier and wherein at least one QFI configured in the predefined radio bearer.

Preferably, the RRC signaling is a SDAP configuration.

Preferably, the synchronization indication is determined by a predefined PDU session.

Preferably, a PDU session ID of the predefined PDU session is determined by an RRC signaling.

Preferably, the first node is a user device and the second node is a network node.

The present disclosure relates to a wireless communication method for use in a second node. The method comprises:
transmitting, to a first node, a configuration signaling which comprises a configuration information associated with synchronizing a plurality of data streams.

Various embodiments may preferably implement the following features:

Preferably, the wireless communication method further comprises performing communications of the plurality of data streams based on the configuration information

Preferably, synchronizing the plurality of data streams comprises at least one of:
processing the plurality of data streams synchronously,
scheduling the plurality of data streams synchronously, or
grouping a plurality of devices associated with the plurality of data streams.

Preferably, the configuration signaling is comprised in a general packet radio service (GPRS) transmission protocol packet, a GPRS transmission protocol (GTP) header, a quality of service (QoS) parameter set, a predefined radio bearer or a predefined protocol data unit (PDU) session.

Preferably, the configuration information comprises at least one of a device cluster indication for a plurality of devices associated with the plurality of data streams or a synchronization indication of synchronizing the plurality of data streams.

Preferably, the device cluster indication comprises at least one of:
a QoS parameter for the plurality of data streams,
device cluster information associated with a device cluster corresponding to the plurality of data streams, or the synchronization indication of synchronizing the plurality of data streams.

Preferably, the device cluster information comprises an association device identifier for a set of device identifiers of devices or a device cluster identifier.

Preferably, the synchronization indication is determined by a synchronization QoS parameter set, a synchronization QoS parameter, or a synchronization QoS flow.

Preferably, the synchronization QoS parameter set comprises at least one of: a minimum packet delay budget within packet delay budgets of the data streams, a maximum packet delay budget within the packet delay budgets of the data streams, an average packet delay budget of the packet delay budgets of the data streams, an offset for the packet delay budgets of the data streams, a reference packet delay budget within the packet delay budgets of the data streams, a time interval of synchronizing the plurality of data streams, a common packet delay budget for each data stream, or a synchronized level.

Preferably, the synchronization QoS parameter set comprises a set of QoS flow identifiers (QFIs).

Preferably, the wireless communication method further comprises synchronizing QoS flows corresponding to the QFIs in the synchronization QoS parameter set.

Preferably, performance characteristics of the data streams are determined based on the synchronization QoS parameter set.

Preferably, performance characteristics of each data stream is determined based on the synchronization QoS parameter set and a performance QoS parameter set, wherein the performance QoS parameter set comprises at least one of a resource type, a default priority level, a packet delay budget for transmission, a packet error rate for transmission, a default maximum data burst volume, or a default averaging window for communications of the data stream.

Preferably, the performance QoS parameter set is determined by a QFI filed in PDU session information.

Preferably, a determination of the synchronization QoS parameter set is based on a first field in PDU session information.

Preferably, an activation/deactivation of the synchronization QoS parameter set is determined based on a second field in PDU session information.

Preferably, the synchronization indication is determined by a radio bearer for the plurality of data streams.

Preferably, the radio bearer is a predefined radio bearer for the synchronization.

Preferably, the radio bearer includes at least one QoS flow of the data streams to be synchronized.

Preferably, the synchronization indication is determined by a PDU session which comprises at least one radio bearer comprising QoS flows of the data streams to be synchronized.

Preferably, the PDU session is determined by a GTP header of the PDU session.

Preferably, a GTP header of the PDU session indicates a synchronization PDU type.

Preferably, the synchronization indication is determined by a GTP header of the synchronization.

Preferably, the GTP header is a type of extension header.

Preferably, the type of extension header is determined by a next extension header type field value.

Preferably, the synchronization indication is determined by a PDU set importance indication for the plurality of data streams.

Preferably, the PDU set importance indication comprises at least one of: a PDU set importance level for the plurality of data streams, a synchronization request indication for synchronizing the plurality of data streams, or a QoS parameter set for synchronizing the plurality of data streams.

Preferably, the first node is a network node and the second node is a core network node.

Preferably, synchronizing the plurality of data streams comprises at least one of: jointly processing the plurality of data streams, jointly indicating the plurality of data streams or, transmitting, to the second node, assistance information associated with the synchronization.

Preferably, the configuration signaling comprises at least one of, a radio resource control signaling, a user equipment capability, a media access control (MAC) control element (CE) signaling, or a downlink control information signaling.

Preferably, the configuration information comprises a synchronization indication for the plurality of data streams.

Preferably, the synchronization indication comprises a predefined radio bearer.

Preferably, the wireless communication further comprises receiving, from the second node, an RRC signaling comprising a predefined radio bearer identifier and wherein at least one QFI configured in the predefined radio bearer.

Preferably, the RRC signaling is a SDAP configuration.

Preferably, the synchronization indication is determined by a predefined PDU session.

Preferably, a PDU session ID of the predefined PDU session is determined by an RRC signaling.

Preferably, the first node is a user device and the second node is a network node.

The present disclosure relates to a wireless communication method for use in a first node. The method comprises:
transmitting, to a second node, a first signaling associated with configuration information associated with synchronizing a plurality of data streams.

Various embodiments may preferably implement the following features:

Preferably, the first signaling comprises downlink transmission assistance information comprising at least one of: offset information for a packet delay budget, time information of the communications of the plurality of data streams, device type information associated with devices corresponding to the plurality of data streams, or traffic type information associated with the plurality of data streams.

Preferably, the offset information comprises an offset of amending the packet delay budget.

Preferably, the offset information comprises a synchronizing margin for the packet delay budget.

Preferably, the time information comprises slot indexes, transmission time interval indexes or time stamp associated with the communications of the plurality of data streams.

Preferably, the first signaling comprises uplink transmission assistance information including at least one of: an indication for a plurality of uplink data streams in one logical channel group (LCG), an indication of a plurality of LCGs, an indication of a plurality of physical uplink shared channels, an indication of a plurality of HARQ process IDs, offset information for a packet delay budget, time information of the communications of the plurality of data streams, device type information associated with devices corresponding to the plurality of data streams, device type information associated with devices corresponding to the plurality of data streams, or traffic type information associated with the plurality of data streams.

Preferably, the first signaling comprises uplink transmission assistance information including an indication for a plurality of uplink data streams in a LCG logical channel group (LCG).

Preferably, data in the plurality of uplink data streams in the LCG comprises at least one of data to be synchronized or data not to be synchronized.

Preferably, the indication for the plurality of uplink data streams in the LCG comprises at least one of an indication of data to be synchronized or an indication of data not to be synchronized.

Preferably, the first signaling comprises uplink transmission assistance information including an indication for an association of a plurality of logical channel groups (LCGs).

Preferably, the association of the plurality of LCGs includes synchronizing data in the plurality of LCGs.

Preferably, the indication is a bitmap indicating the plurality of LCGs.

Preferably, the indication is a bit string indicating a group identifier of the plurality of LCGs, wherein the data in the LCGs indicated by the same group identifier is to be synchronized.

Preferably, data in logic channels within the plurality of LCG are scheduled based on a scheduling rule.

Preferably, the scheduling rule includes at least one of: simultaneous scheduling, scheduling following restriction based on synchronization requirement in configuration information.

Preferably, logic channels within the plurality of LCGs have at least one of: a same logic channel priority, a same prioritized bit rate, or a same bucket size duration.

Preferably, the first signaling comprises at least one of: UE capability, UE assistance information, a MAC CE signaling, or an uplink control information signaling.

Preferably, the MAC CE signaling is a buffer size report (BSR).

Preferably, information comprised in the first signaling is in a dedicated octet of the BSR.

Preferably, the BSR is a short BSR, a long BSR, an extended short BSR, an extended long BSR, or an extended pre-emptive BSR.

Preferably, the first signaling comprises the MAC CE signaling and downlink transmission assistance information and/or uplink transmission assistance information comprised in the first signaling is in a MAC sub-header of the MAC CE signaling

Preferably, the uplink control information signaling comprises at least one of an uplink control information for resource release, or HARQ ACK information or a channel state information.

Preferably, the first node is a user device and the second node is a network node.

The present disclosure relates to a wireless communication method for use in a second node. The method comprises receiving, from a first node, a first signaling associated with configuration information associated with synchronizing a plurality of data streams.

Various embodiments may preferably implement the following features:

Preferably, the first signaling comprises downlink transmission assistance information comprising at least one of: offset information for a packet delay budget, time information of the communications of the plurality of data streams, device type information associated with devices corresponding to the plurality of data streams, or traffic type information associated with the plurality of data streams.

Preferably, the offset information comprises an offset of amending the packet delay budget.

Preferably, the offset information comprises a synchronizing margin for the packet delay budget.

Preferably, the time information comprises slot indexes, transmission time interval indexes or time stamp associated with the communications of the plurality of data streams.

Preferably, the first signaling comprises uplink transmission assistance information including at least one of: an indication for a plurality of uplink data streams in one logical channel group (LCG), an indication of a plurality of LCGs, an indication of a plurality of physical uplink shared channels, an indication of a plurality of HARQ process IDs, offset information for a packet delay budget, time information of the communications of the plurality of data streams, device type information associated with devices corresponding to the plurality of data streams, device type information associated with devices corresponding to the plurality of data streams, or traffic type information associated with the plurality of data streams.

Preferably, the first signaling comprises uplink transmission assistance information including an indication for a plurality of uplink data streams in a LCG logical channel group (LCG).

Preferably, data in the plurality of uplink data streams in the LCG comprises at least one of data to be synchronized or data not to be synchronized.

Preferably, the indication for the plurality of uplink data streams in the LCG comprises at least one of an indication of data to be synchronized or an indication of data not to be synchronized.

Preferably, the first signaling comprises uplink transmission assistance information including an indication for an association of a plurality of logical channel groups (LCGs).

Preferably, the association of the plurality of LCGs includes synchronizing data in the plurality of LCGs.

Preferably, the indication is a bitmap indicating the plurality of LCGs.

Preferably, the indication is a bit string indicating a group identifier of the plurality of LCGs, wherein the data in the LCGs indicated by the same group identifier is to be synchronized.

Preferably, data in logic channels within the plurality of LCG are scheduled based on a scheduling rule.

Preferably, the scheduling rule includes at least one of: simultaneous scheduling, scheduling following restriction based on synchronization requirement in configuration information.

Preferably, logic channels within the plurality of LCGs have at least one of: a same logic channel priority, a same prioritized bit rate, or a same bucket size duration.

Preferably, the first signaling comprises at least one of: UE capability, UE assistance information, a MAC CE signaling, or an uplink control information signaling.

Preferably, the MAC CE signaling is a buffer size report (BSR).

Preferably, information comprised in the first signaling is in a dedicated octet of the BSR.

Preferably, the BSR is a short BSR, a long BSR, an extended short BSR, an extended long BSR, or an extended pre-emptive BSR.

Preferably, the first signaling comprises the MAC CE signaling and downlink transmission assistance information and/or uplink transmission assistance information comprised in the first signaling is in a MAC sub-header of the MAC CE signaling

Preferably, the uplink control information signaling comprises at least one of an uplink control information for resource release, or HARQ ACK information or a channel state information.

Preferably, the first node is a user device and the second node is a network node.

The present disclosure relates to a first node. The first node comprises:
a communication unit, configured to receive, from a second node, a configuration signaling which comprises a configuration information associated with synchronizing a plurality of data streams.

Various embodiments may preferably implement the following feature:

Preferably, the first node further comprises a processor configured to perform any of the aforementioned wireless communication methods.

The present disclosure relates to a second node. The second node comprises:
a communication unit, configured to transmit, to a first node, a configuration signaling which comprises a configuration information associated with synchronizing a plurality of data streams.

Various embodiments may preferably implement the following feature:

Preferably, the second node further comprises a processor configured to perform any of the aforementioned wireless communication methods.

The present disclosure relates to a first node. The first node comprises:
a communication unit, configured to transmit, to a second node, a first signaling associated with configuration information associated with synchronizing a plurality of data streams.

Various embodiments may preferably implement the following feature:

Preferably, the first node further comprises a processor configured to perform any of the aforementioned wireless communication methods.

The present disclosure relates to a second node. The second node comprises:
a communication unit, configured to receive, from a first node, a first signaling associated with configuration information associated with synchronizing a plurality of data streams.

Various embodiments may preferably implement the following feature:

Preferably, the second node further comprises a processor configured to perform any of the aforementioned wireless communication methods.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The invention is specified by the independent claims. Preferred embodiments are defined in the dependent claims. In the following description, although numerous features may be designated as optional, it is nevertheless acknowledged that all features comprised in the independent claims are not to be read as optional.

The above and other aspects and their implementations are described in greater detail in the drawings, the descriptions, and the claims.

### BRIEF DESCRIPTION OF THE DRAWINGS

FIG. 1 shows a schematic diagram of a synchronization according to an embodiment of the present disclosure.

FIG. 2 shows a schematic diagram of a synchronization according to an embodiment of the present disclosure.

FIG. 3 shows a schematic diagram of a synchronization according to an embodiment of the present disclosure.

FIG. 4 shows a schematic diagram of a network (architecture) according to an embodiment of the present disclosure.

FIG. 5 shows a schematic diagram of data streams according to an embodiment of the present disclosure.

FIG. 6 shows a schematic diagram of data streams according to an embodiment of the present disclosure.

FIG. 7 shows a schematic diagram of a short BSR according to an embodiment of the present disclosure.

FIG. 8 shows a schematic diagram of a long BSR according to an embodiment of the present disclosure.

FIG. 9 shows a schematic diagram of a long BSR according to an embodiment of the present disclosure.

FIG. 10 shows a schematic diagram of a MAC subheader according to an embodiment of the present disclosure.

FIG. 11 shows a schematic diagram of a MAC subheader according to an embodiment of the present disclosure.

FIG. 12 shows an example of a schematic diagram of a wireless terminal according to an embodiment of the present disclosure.

FIG. 13 shows an example of a schematic diagram of a wireless network node according to an embodiment of the present disclosure.

### DETAILED DESCRIPTION

In an embodiment, the metaverse and multi-modality service includes multiple data streams (such as video stream, audio stream, haptic stream and so on) with different quality of service (QoS) requirements. In order to have an immersive experience, the multiple data streams may need to be synchronized, to make the virtual world more vivid. Note that the multiple data streams may belong to either one single device or multiple devices.

In an embodiment, synchronization information (such as synchronization indication, key performance indicator) is able to be transmitted through core network (CN). When a base station receives the synchronization information transmitted by the CN, the base station can transmit the corresponding information to the UE, to request certain assistance information for downlink transmissions, and/or to jointly process the data streams to be synchronized, and/or to jointly schedule the data streams to be synchronized and/or to group the data streams of different devices to be synchronized (e.g., the devices to which the synchronized data streams belong). In addition, the UE may be capable of transmitting the assistance information to the base station, so as to have UL (uplink) synchronized data stream transmissions.

In some embodiments, a device cluster indication (i.e., an indication for a device cluster) is proposed.

In an embodiment, the data streams of the devices in the same device cluster are tagged with the same QoS parameter set. That is the QoS parameter set may be used as the device cluster indication.

In an embodiment, devices in the same device cluster are indicated by an association device identifier, such as a set of device identifiers of devices and a device cluster identifier. In this embodiment, the devices indicated by the association device identifier may be considered in the same device cluster.

In an embodiment, the association device identifier includes one or more device identifier(s) or device cluster identifier(s).

In some embodiments, a synchronization indication is proposed.

In an embodiment, devices may be determined to be in the same device cluster based on the device cluster indication(s) for the devices, while synchronization requirements for these devices are determined by the synchronization indication separately.

In an embodiment, devices are determined to be in the same device cluster based on the synchronization indication(s) for the devices. In this embodiment, the synchronization requirements for these devices are also determined based on the synchronization indication(s) for the devices.

In an embodiment, the synchronization indication is an implicit indication or an explicit indication.

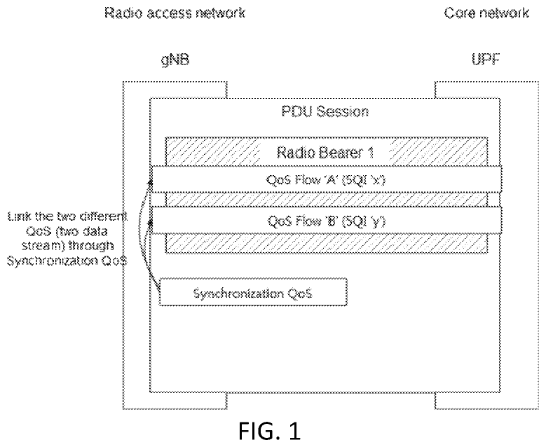

FIG. 1 shows a schematic diagram of a synchronization according to an embodiment of the present disclosure. In this embodiment, a synchronization QoS (parameter set) is configured for QoS flows ‘A’ and ‘B’ which are (needed) to be synchronized.

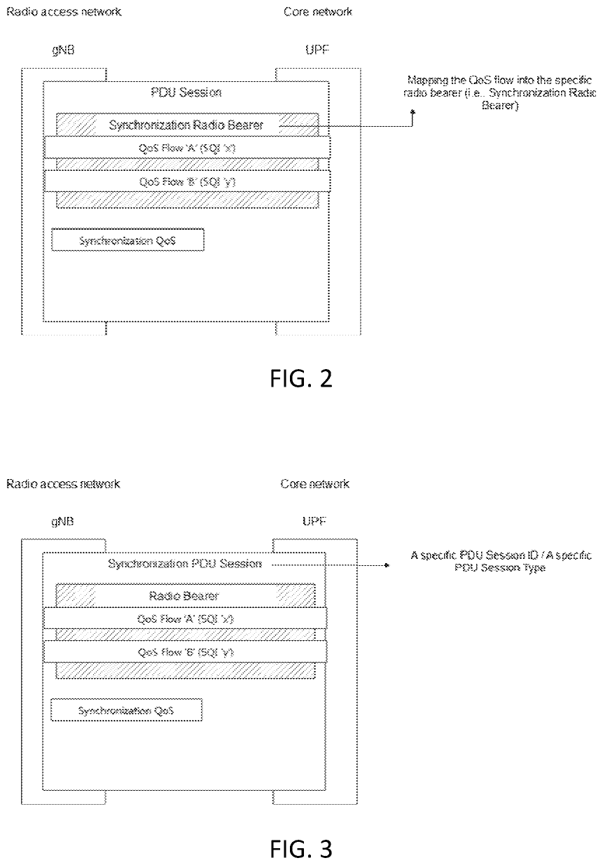

FIG. 2 shows a schematic diagram of a synchronization according to an embodiment of the present disclosure. In FIG. 2, a synchronization radio bearer is configured for the QoS flows ‘A’ and ‘B’ which are (needed) to be synchronized.

FIG. 3 shows a schematic diagram of a synchronization according to an embodiment of the present disclosure. In FIG. 3, a synchronization PDU session is configured for the QoS flows ‘A’ and ‘B’ which are (needed) to be synchronized.

Note that the number of QoS flows (needed) to be synchronized may be more than 2.

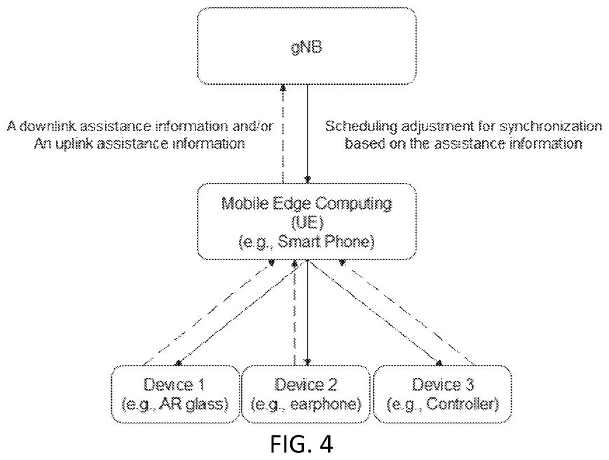

FIG. 4 shows a schematic diagram of a network (architecture) according to an embodiment of the present disclosure. In FIG. 4, a UE reports the assistance information (e.g., downlink assistance information and/or uplink assistance information) to a gNB. The UE may be a mobile edge computing device (e.g., a smart phone) and connects to multiple devices 1, 2 and 3. For example, the device 1 may be an AR (Augmented Reality) glass, the device 2 may be an earphone, and the device 3 may be a controller. The data streams associated with the devices 1, 2 and 3 may need to be synchronized, e.g., to provide an immersive experience.

In an embodiment, the report of synchronization information may be triggered by the UE capability and/or a transmission of relevant information from the gNB.

In an embodiment, the synchronization information comprises at least one of:
Offset information, (e.g., PDB (packet delay budget) revise value, UE synchronization margin);
   Slot/TTI (transmission time interval) index when the data is received successfully;
   Time stamp when the data is received successfully;
   Device type;
   Traffic type;
   Identifier for synchronized data and non-synchronized data (Uplink); or
   Identifier for synchronized data from different logical channel groups (Uplink).

In an embodiment, the signaling for reporting the synchronization information may comprise at least one of:
UE assistance information (e.g., RRC signaling);
MAC CE signaling; or
UCI signaling.

In an embodiment, a method for use in a first node is disclosed. The method comprises:
receiving, from a second node, a configuration signaling comprising synchronization/configuration information associated with synchronizing a plurality of data streams.

In an embodiment, the method further comprises determining the synchronization/configuration information based on the configuration signaling.

In an embodiment, the method further comprises transmitting, to the second node, a first signaling associated with the synchronization information.

In the present disclosure, the following items are further discussed:
The interpretation of the first node and the second node;
The interpretation of the configuration signaling;
The interpretation of the synchronization information; and
The interpretation of the first signaling.

### Interpretation of First Node and Second Node

In some embodiments, the second node is/comprises one of: a core network (CN) node or a network node (e.g., Base station).

In some embodiments, the first node comprises one of: a network node (e.g., Base station) or a network device (e.g., UE).

### Interpretation of Configuration Signaling

In some embodiments of the second node being the CN node and the first node being the network node, the configuration signaling is transmitted through/comprised in a general packet radio service (GPRS) transmission protocol packet.

In an embodiment, the GPRS transmission protocol packet refers to at least one of:
a GPRS transmission protocol (GTP) header;
a quality of service (QoS) parameter set;
a predefined radio bearer, or
a predefined PDU session.

In some embodiments, if the second node is the CN node and the second node is the network node, the configuration signaling includes the configuration information.

In some embodiments of the second node being the network node and the first node being the network device, the configuration signaling is transmitted through at least one of:
High layer parameter;
RRC signaling;
UE capability;
MAC (Medium access control) CE signaling; or
DCI (Downlink control information) signaling

In some embodiments, if the second node is the network node and the first node is the network device, the configuration signaling includes a configuration information.

### Interpretation of Configuration Information

In some embodiments of the second node being the CN node and the first node being the network node, the configuration information transmitted from the CN node to network node is used to help the network node to synchronize the plurality of data streams. In an embodiment, synchronizing the plurality of data streams comprises or refers to processing the plurality of data streams synchronously.

In an embodiment, synchronously processing the plurality of data streams includes at least one of gathering/grouping the data streams needed to be synchronized, providing an association for the data streams needed to be synchronized, synchronously processing the data streams for the devices in the group, or jointly encoding the data in the data streams.

In some embodiments of the second node being the CN node and the first node being the network node, the configuration information transmitted from the CN node to the network node is used to help the network node to synchronize the plurality of data streams. In this embodiment, the synchronizing the plurality of data streams comprises or refers to scheduling the plurality of data streams synchronously.

In an embodiment, synchronously scheduling the plurality of data streams includes at least one of scheduling the plurality of data streams simultaneously, scheduling the plurality of data streams within a time restriction, or synchronously scheduling the data streams for the devices in the group.

In some cases, the time restriction is determined by a synchronization request/requirement within the configuration information.

In some embodiments of the second node being the CN node and the first node being the network node, the configuration information transmitted from the CN node to network node is used to help the network node synchronize the plurality of data streams. In this embodiment, the synchronizing the plurality of data streams comprises or refers to grouping a plurality of devices associated with the plurality of data streams or with a device coordination.

In an embodiment, grouping the plurality of devices associated with the plurality of data streams includes at least one of identifying the devices in the same group (e.g., the same device cluster) or categorizing the plurality of data streams for the plurality of device in the same group (e.g., the same device cluster).

In an embodiment, the device coordination refers to grouping the devices having the data streams (needed) to be synchronized.

In some embodiments, if the second node is the CN node and the first node is the network node, the configuration information includes at least one of:
Device cluster indication; or
Synchronization indication.

In an embodiment, the device cluster indication is used to determine a device group for at least one of synchronization, joint scheduling processing, or device coordination.

In some embodiments, if the second node is the CN node and the first node is the network node, the first information includes the device cluster indication.

In some embodiments, the device cluster indication includes at least one of:
a QoS parameter set;
device cluster information; or
the synchronization indication.

In an embodiment, the device cluster information comprises an association device identifier for a set of device identifiers.

In some cases, the set of device identifiers includes/has a single joint/common identifier.

As an alternative, the association device identifier is a specific (e.g., predefined) device identifier for grouping the devices, where the devices in the same group (device cluster) are indicated by the association device identifier.

As an alternative, the association device identifier is an anchor device identifier which belongs to an anchor device. The devices which belong to the same group (device cluster) as the anchor device are indicated by the anchor identifier.

As an alternative, the association device identifier is a group (device cluster) identifier, where the devices in the same group (device cluster) are indicated by the group (device cluster) identifier.

In some cases, the set of device identifiers includes a set of identifiers, where the devices in the same group (device cluster) are indicated by one device identifier within the set of device identifiers.

For example, the set of device identifiers is {1, 2, 3, 4, 5} for one group (device cluster). In this example, the device with the device identifier 1, 2, 3, 4, or 5 belongs to this group, while the device having device identifier other than 1 to 5 (e.g., 6) does not belong to this group.

In an embodiment of the device cluster indication comprising the synchronization indication, the device cluster indication indicates both the device cluster for multiple devices and the request for synchronization.

In some embodiments, if the second node is the CN node and the first node is the network node, the configuration information includes the synchronization indication.

In an embodiment, the synchronization indication is determined by a synchronization QoS parameter set.

In some cases, the synchronization QoS parameter set is a QoS profile.

In an embodiment, the synchronization QoS parameter set includes a set of QoS parameters comprising at least one of:
a resource Type,
a default priority level,
a packet delay budget,
a packet error rate,
a default maximum data burst volume,
default averaging window, or
synchronization requirement.

In some cases, the QoS parameter is a performance characteristic.

In some cases, the synchronization requirement is an offset for each data stream, where the offset is a range of value for the QoS parameter “packet delay budget” (PDB) for each data stream. The latency requirement of the data stream is a joint consideration of QoS parameter PDB and the offset, e.g., PDB+offset. Moreover, the offset can be one or more negative values, one or more positive values and/or zero value.

In some cases, the synchronization requirement is a relative/reference packet delay budget for data streams, where the relative/reference packet delay budget (PDB) for (each) data stream is a PDB associated with a reference point. The reference point may be determined by a reception of the anchor data stream.

For example, there are three data streams, such as data stream 1, data stream 2 and data stream 3, needed to be synchronized. Data stream 2 is regarded/set as the anchor data stream. Assuming that data stream 2 is received successfully in a time point 1 millisecond which is set as the reference point and the relative reference PDB is 2 milliseconds. Under such condition, the data stream 1 and the data stream 3 are expected to be received no later than a time point of 1+2=3 milliseconds, so as to achieve the synchronization of the data streams 1, the data stream 2 and the data stream 3.

In some cases, the synchronization requirement is the time interval of synchronizing the plurality of data streams, where the time interval indicates the maximum time interval of the reception time between two synchronized data streams.

For example, there are three data streams (i.e., data stream 1, data stream 2 and data stream 3) needed to be synchronized. The time interval between the reception times of the data stream 1 and the data stream 2 is expected to be smaller than the maximum time interval between the reception times of the data stream 1 and the data stream 2. Similarly, the time interval between the reception times of the data stream 1 and the data stream 3 is expected to be smaller than the maximum time interval between the reception times of the data stream 1 and the data stream 3, and so on.

In some cases, the synchronization requirement is the minimum packet delay budget among data streams.

For example, the data stream 1 has the QoS parameter packet delay budget 1 (PDB1), the data stream 2 has the QoS parameter PDB2, and the data stream 3 has the QoS parameter PDB3. The QoS parameter synchronization requirement can be derived by Min (PDB1, PDB2, PDB3), where Min(*) is the operator for finding the minimum value among the input values.

In some cases, the synchronization requirement is the maximum packet delay budget among data streams.

For example, the data stream 1 has the QoS parameter PDB1, the data stream 2 has the QoS parameter PDB2, and the data stream 3 has the QoS parameter PDB3. The QoS parameter synchronization requirement can be derived by Max (PDB1, PDB2, PDB3), where Max(*) is the operator for finding the maximum value among the input values.

In some cases, the synchronization requirement is the average packet delay budget among data streams.

For example, the data stream 1 has the QoS parameter PDB1, the data stream 2 has the QoS parameter PDB2, and the data stream 3 has the QoS parameter PDB3. The QoS parameter synchronization requirement can be derived as Avg (PDB1, PDB2, PDB3), where Avg(*) is the operator for calculating the average of the input values.

In some cases, the synchronization requirement is a common packet delay budget for each data stream.

In some cases, the synchronization requirement is a synchronization level, where the synchronization level determines the importance of synchronization or degree of synchronization.

As an alternative, different synchronization levels correspond/refer to different offset values.

As an alternative, different synchronization levels correspond/refer to different relative/reference PDBs.

As an alternative, different synchronization levels correspond/refer to different maximum time intervals of synchronization.

In an embodiment, the synchronization QoS parameter set includes: synchronization requirement.

In some cases, the synchronization requirement comprises/is associated with performance characteristic(s).

In some cases, the synchronization requirement comprises an offset for each data stream, where the offset indicates a value range of the QoS parameter PDB for each data stream. That is the latency requirement is a joint consideration of the QoS parameter PDB and the offset, e.g., PDB+offset. Moreover, the offset can be one or more negative values, one or more positive values and/or zero value.

In some cases, the synchronization requirement comprises a relative/reference PDB for data streams, where the relative/reference PDB for (each) data stream indicates a PDB range relative to a reference point. In an embodiment, the reference point is determined by the reception of the anchor data stream.

For example, there are three data streams 1, 2 and 3 which are needed to be synchronized, where the data stream 2 is regarded/set as the anchor data stream. In this example, the data stream 2 is received successfully in a time point 1 millisecond which is set as the reference point and the relative reference PDB is 2 millisecond. Under such condition, the data stream 1 and the data stream 3 are expected to be received no later than the time point 1+2=3 millisecond. If the data stream 1 and/or the data stream 3 is received after the time point 1+2=3, the data stream 1, data stream 2 and data stream 3 are not synchronized.

In some cases, the synchronization requirement comprises the time interval of synchronizing the plurality of data streams, where the time interval indicates/means the maximum time interval between the reception times of two data streams to be synchronized.

For example, there are three data streams 1, 2 and 3 needed to be synchronized. The time interval between the reception times of the data stream 1 and the data stream 2 is expected to be smaller than the maximum time interval between the reception times of the tdata stream 1 and the data stream 2, the time interval between the reception times of the data stream 1 and the data stream 3 is expected to be smaller than the maximum time interval between the reception times of the data stream 1 and the data stream 3, and so on.

In some cases, the synchronization requirement comprises the minimum packet delay budget among the packet delay budgets for the data streams.

For example, the data stream 1 has the QoS parameter PDB1, the data stream 2 has the QoS parameter PDB2 and the data stream 3 has the QoS parameter PDB3. The QoS parameter synchronization requirement can be derived by Min (PDB1, PDB2, PDB3), where Min(*) is the operator for finding the minimum value among the input values/variables.

In some cases, the synchronization requirement is the maximum packet delay budget among the packet delay budgets for the data streams.

For example, the data stream 1 has the QoS parameter PDB1, the data stream 2 has the QoS parameter PDB2 and the data stream 3 has the QoS parameter PDB3. The QoS parameter synchronization requirement can be derived by Max (PDB1, PDB2, PDB3), where Max(*) is the operator for finding the maximum value among the input values/variables.

In some cases, the synchronization requirement is the average packet delay budget among data streams.

For example, the data stream 1 has the QoS parameter PDB1, the data stream 2 has the QoS parameter PDB2, and the data stream 3 has the QoS parameter PDB3. The QoS parameter synchronization requirement can be derived by Avg (PDB1, PDB2, PDB3), where Avg(*) is the operator for calculating the average of the input values/variables.

In some cases, the synchronization requirement comprises a common packet delay budget for each data stream.

In some cases, the synchronization requirement is a synchronization level, where the synchronization level determines the importance of synchronization or degree of synchronization.

As an alternative, different synchronization levels correspond/refer to different offset values.

As an alternative, different synchronization levels correspond/refer to different relative/reference PDBs.

As an alternative, different synchronization levels corresponds/refer to different maximum time intervals of synchronization.

In an embodiment, the synchronization QoS parameter set includes: a set of the QoS flow identifier (QFI), where QFI is relevant to the index (value) of the QoS parameter set.

In some cases, the index (value) of the QoS parameter set is a 5QI value.

In some cases, the data streams in the set of the QoS flows indicated by the QoS parameter set are needed to be synchronized.

For example, the QoS parameter set includes the QFIs including e.g., {1, 2, 3, 4, 5}. In this example, there are the data stream 1 with QFI=1, the data stream 2 with QFI=3 and the data stream 3 with QFI=6. Based on the QFIs {1, 2, 3, 4, 5}, the data stream 1 and the data stream 2 need to be synchronized, while the data stream 3 does not need to be synchronized with the data stream 1 and the data stream 2.

In some embodiments, the performance characteristics of the data streams are determined based on the synchronization QoS parameter set.

In an embodiment, the data streams are requested to be synchronized.

In an embodiment, all performance characteristics of the data stream are determined by the synchronization QoS parameter set, including: a resource type, a default priority level, a packet delay budget, a packet error rate, a default maximum data burst volume, default averaging window, and synchronization requirement.

In an embodiment, a part of performance characteristics of the data stream is determined by a performance QoS parameter set, including: a resource type, a default priority level, a packet delay budget, a packet error rate, a default maximum data burst volume and default averaging window, while the remaining part of performance characteristics of the data streams is determined by a synchronization QoS parameter set, including e.g., synchronization requirement.

In some embodiments, the synchronization QoS parameter set is determined by protocol data unit (PDU) session information.

In an embodiment, a first field within PDU session information is used to determine the synchronization QoS parameter set.

In some cases, the synchronization QoS parameter set is determined by selecting one index (value) corresponding to the synchronization QoS parameter set.

As an alternative, the index (value) is a 5QI value.

In some cases, the first field is a specific field in the PDU session information, e.g., synchronization QoS identifier (SQI).

In some cases, the first field is a QFI field.

In an embodiment, a second field within the PDU session information is used to activate/inactivate the usage of the synchronization QoS parameter set.

In some cases, the second field includes at least one bit for activating/inactivating the usage of the synchronization QoS parameter set.

For example, the bit ‘1’ indicates activating the usage of synchronization QoS parameter set and the bit ‘0’ indicates inactivating the usage of synchronization QoS parameter set.

In some cases, the second field is a specific field, such as synchronization QoS activation (SQA) in the PDU session information.

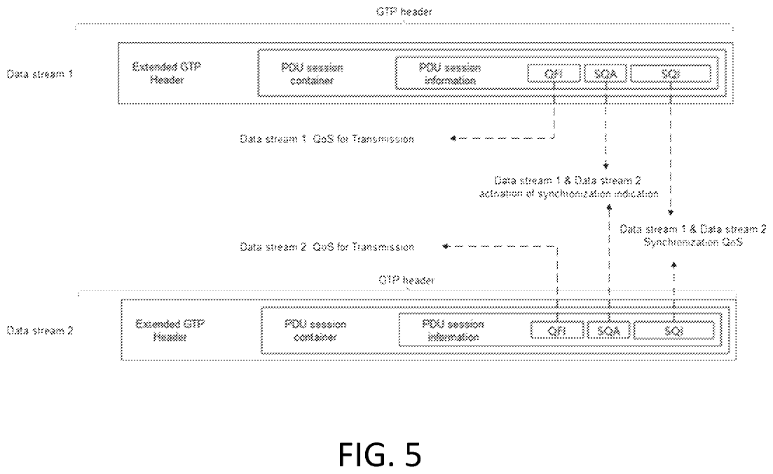

FIG. 5 shows a schematic diagram of data streams according to an embodiment of the present disclosure. In FIG. 5, a field SQA (Synchronization QoS activation) is used to activate/inactivate the usage of the synchronization QoS parameter set. In addition, a field SQI (Synchronization QoS Identifier) is used to indicate the synchronization QoS parameter set (e.g., including the synchronization indication or for synchronization). For example, the SQI may comprises the QFI of the QoS parameter set. In this embodiment, the data streams 1 and 2 are needed to be synchronized. The SQAs for the data streams 1 and 2 activate the (synchronization) QoS parameter indicated by the SQIs.

In some embodiments, the synchronization indication is determined by a radio bearer (see, e.g., FIG. 2).

In an embodiment, the QoS flows of data streams (needed) to be synchronized belongs to a predefined radio bearer. That is the predefined radio bearer is configured to synchronizes the data stream in the QoS flows it contains.

In an embodiment, the predefined radio bearer identifier is determined by the CN node.

In some embodiments, the synchronization indication is determined by a PDU session (see, e.g., FIG. 3).

In an embodiment, the data streams (needed) to be synchronized are all transmitted in a predefined PDU session.

In an embodiment, the predefined PDU session is determined by a GTP header.

In an embodiment, the PDU session is determined by a dedicated type of PDU session type, e.g., synchronized PDU session type.

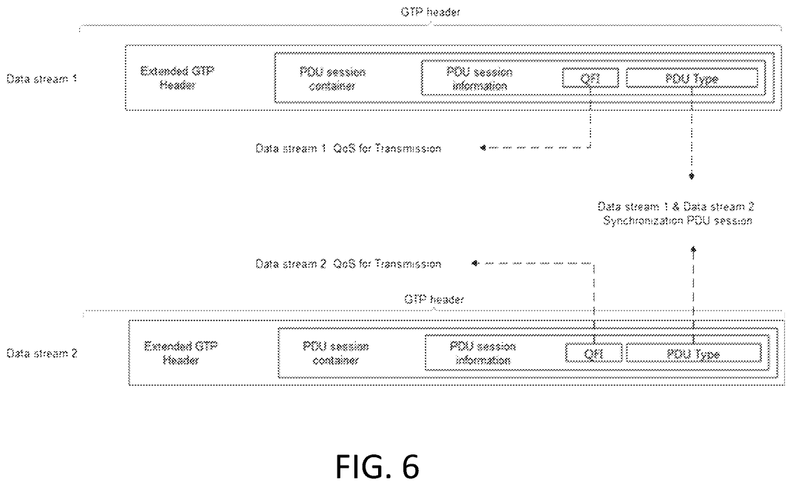

FIG. 6 shows a schematic diagram of data streams according to an embodiment of the present disclosure. In FIG. 5, the data streams 1 and 2 are needed to be synchronized. In this embodiment, the PDU types of the data streams 1 and 2 are configured to be the synchronized PDU session type. That is the PDU session types is the indication for synchronization.

In some embodiments, the synchronization indication is determined by a PDU set importance indication.

In an embodiment, the PDU set importance indication includes: a PDU set importance level for the plurality of data streams; a synchronization request indication for synchronizing the plurality of data streams; and a QoS parameter set for synchronizing the plurality of data streams.

In an embodiment, the PDU set importance indication includes: a PDU set importance level for the plurality of data streams and a synchronization request indication for synchronizing the plurality of data streams.

In an embodiment, the PDU set importance indication includes: a PDU set importance level for the plurality of data streams and a QoS parameter set for synchronizing the plurality of data streams.

In an embodiment, the PDU set importance level for the plurality of data streams indicates the importance degree of the data stream. In an embodiment, the most important data stream is processed or scheduled firstly and/or cannot be discard when congestion occurs.

In some cases, one PDU set importance level corresponds to one data stream.

In some cases, one PDU set importance level corresponds to the data streams need to be synchronized.

In an embodiment, the synchronization request indication for synchronizing the plurality of data streams includes the activation/inactivation of the usage of synchronization QoS parameter set and an index (value) corresponding to the synchronization QoS parameter set.

In an embodiment, the synchronization request indication for synchronizing the plurality of data streams includes the activation/inactivation of the usage of synchronization QoS parameter set.

In an embodiment, the synchronization request indication for synchronizing the plurality of data streams includes the index (value) corresponding to the synchronization QoS parameter set.

In an embodiment, a QoS parameter set includes a synchronization QoS parameter set. For example, QoS parameters within this QoS parameter set includes a part of the QoS parameters in the synchronization QoS parameter set, including e.g., the packet error rate, the packet delay budget and the synchronization requirement.

In an embodiment, a QoS parameter set includes a synchronization QoS parameter set and a performance QoS parameter set.

In an embodiment, a QoS parameter set includes a performance QoS parameter set.

For instance, QoS parameters within the QoS parameter set includes a part of the QoS parameters in the performance QoS parameter set, including e.g., the packet error rate and the packet delay budget.

In some embodiments, the synchronization indication is determined by a GTP-U header.

In an embodiment, the synchronization indication is determined by the specific GTP header for synchronization indication, i.e., synchronization GTP header.

In an embodiment, the synchronization indication is determined by “Next Extension Header Type” in the GTP header. In this embodiment, the synchronization indication is one of plurality of types of extended header.

For example, the synchronization indication is in the “Next Extension Header Type” corresponds to value 0000 0100 in the following Table 1:

TABLE 1

| Next Extension Header | |
|---|---|
| Field Value | Type of Extension Header |
| 0000 0000 | No more extension headers |
| 0000 0001 | Reserved - Control Plane only. |
| 0000 0010 | Reserved - Control Plane only. |
| 0000 0011 | Long PDCP PDU Number. |
| | See NOTE 2. |
| 0000 0100 | Synchronization indication |
| 0010 0000 | Service Class Indicator |
| 0100 0000 | UDP Port. Provides the UDP Source Port of the |
| | triggering message. |
| 1000 0001 | RAN Container |
| 1000 0010 | Long PDCP PDU Number. |
| | See NOTE 3. |
| 1000 0011 | Xw RAN Container |
| 1000 0100 | NR RAN Container |
| 1000 0101 | PDU Session Container. See NOTE 4. |
| 1100 0000 | PDCP PDU Number [4]-[5]. See NOTE 1. |
| 1100 0001 | Reserved - Control Plane only. |
| 1100 0010 | Reserved - Control Plane only. |

In some embodiments of the second node being the network node and the first node being the network device, the synchronization of the plurality of data streams comprises (or refers to) at least one of jointly processing the plurality of data streams, jointly indicating the plurality of data streams or transmitting, to the second node, assistance information associated with the synchronization.

In some embodiments of the second node being the network node and the first node being the network device, the synchronization of the plurality of data streams comprises (or refers to) jointly processing the plurality of data streams jointly indicating the plurality of data streams.

In some embodiments of the second node being the network node and the first node being the network device, the synchronization of the plurality of data streams comprises (or refers to) jointly processing the plurality of data streams transmitting, to the second node, assistance information associated with the synchronization.

In some embodiments of the second node being the network node and the first node being the network device, the synchronization of the plurality of data streams comprises (or refers to) jointly indicating the plurality of data streams and transmitting, to the second node, assistance information associated with the synchronization.

In some embodiments of the second node being the network node and the first node being the network device, the synchronization of the plurality of data streams comprises (or refers to) jointly processing the plurality of data streams.

In some embodiments of the second node being the network node and the first node being the network device, the synchronization of the plurality of data streams comprises (or refers to) jointly indicating the plurality of data streams.

In some embodiments of the second node being the network node and the first node being the network device, the synchronization of the plurality of data streams comprises (or refers to) transmitting, to the second node, assistance information associated with the synchronization.

In some embodiments of the second node being the network node and the first node being the network device, the configuration information transmitted from the network node to the network device is used to indicate the network device to synchronize the plurality of data streams by processing the plurality of data streams synchronously.

In an embodiment, processing the plurality of data streams synchronously includes at least one of gathering/grouping the data streams (needed) to be synchronized, providing some association for the data streams needed to be synchronized, synchronously receiving data streams (needed) to be synchronized, synchronously processing the data streams for the devices in the group, or jointly encoding the data of the data streams.

In some embodiments of the second node being the network node and the first node being the network device, the configuration information transmitted from the network node to the network device is used to indicate the network device to synchronize the plurality of data streams via jointly indicating the plurality of data streams.

In an embodiment, jointly indicating the plurality of data streams includes indicating the data streams (needed) to be synchronized and/or indicating the data streams which are not (needed) to be synchronized.

In some embodiments of the second node being the network node and the first node being the network device, the configuration information transmitted from the network node to the network device is used to indicate the network device to synchronize the plurality of data streams via transmitting the assistance information associated with synchronization to the network node.

In some embodiments of the second node being the network node and the first node being the network device, the configuration information includes the synchronization indication.

In an embodiment, the synchronization indication is determined by the predefined radio bearer.

In an embodiment, the QFIs in the predefined radio bearer are determined by an RRC (radio resource control) signaling.

In some cases, the RRC signaling is SDAP-config.

As an alternative, a dedicated parameter mappedQoS-FlowSyncToAdd-r18 in the following Table 2 for SDAP-config is configured to map the QoS flows needed to be synchronized into the predefined radio bearer.

TABLE 2
SDAP-Config

| | |
|---|---|
| pdu-session | INTER (0 . . . 255) |
| sdap-HeaderDL | ENUMERATED {present, absent} |
| sdap-HeaderUL | ENUMERATED {present, absent} |
| defaultDRB | BOOLEAN |
| mappedQoS- | SEQUENCE (SIZE (1 . . . maxNrofQFIs)) OF QFI |
| FlowsToAdd | |
| mappedQoS- | SEQUENCE (SIZE (1 . . . maxNrofQFIs)) OF QFI |
| FlowsToRelease | |
| mappedQoS- | SEQUENCE (SIZE (1 . . . maxNrofQFIs)) OF QFI |
| FlowSyncToAdd- | Note: QFI for the QoS flow needed to be |
| r18 | synchronized. |

In some embodiments, the synchronization indication is determined by the PDU session.

In an embodiment, the PDU session for synchronization is determined by a RRC signaling

In some cases, the RRC signaling is the SDAP-config, where at least one synchronized PDU session ID is determined by the parameter pdu-session. For example, the integers {10, 20, 30} for the parameter pdu-session may be selected as the synchronized PDU session ID.

### Interpretation of First Signaling

In some embodiments, a first signaling is transmitted by the UE to, e.g., base station or CN node.

In an embodiment, the UE transmits the first signaling when receiving the synchronization information.

In an embodiment, the first signaling includes downlink transmission assistance information, comprising at least one of:
offset information;
time information when data stream is received/transmitted;
device type information; or
traffic type information.

In some embodiments, the offset information is a packet delay budget amendment.

In an embodiment, the packet delay budget amendment is used for adjusting the packet delay budget within the performance QoS parameter set, for the corresponding data stream

For example, the packet delay budget within the performance QoS parameter set is A and the packet delay budget amendment set as B is reported to adjust the latency requirement to be A+B or A−B.

In an embodiment, the packet delay budget amendment is used for adjusting the synchronization requirement within the synchronization QoS parameter set for the corresponding data stream.

In some embodiments, the offset information is a synchronization margin.

In an embodiment, the synchronization margin is used for determining or revising the synchronization requirement within the synchronization QoS parameter set.

In some cases, the synchronization requirement within the synchronization QoS parameter set is replaced by the reported synchronization margin.

In some embodiments, the time information is a slot index of the successful reception for packet of the data stream.

In an embodiment, the slot index is from a first device (e.g., one of devices 1 to 3 in FIG. 4).

In some embodiments, the time information is a transmission time interval (TTI) index of the successful reception for packet of the data stream.

In an embodiment, the TTI index is from the first device.

In some embodiments, the time information is a time stamp of the successful reception for packet of the data stream.

In an embodiment, the time stamp is from the first device.

In some embodiments, the first device connects with a second device (e.g., UE in FIG. 4), where the second device connects with the network node (e.g., gNB)

In some embodiments, there are multiple data streams in a single device or in multiple devices, and the multiple data streams are necessary to be synchronized. The slot, TTI or time stamp is reported to adjust the scheduling time for synchronized for the following transport block or the following packets.

In some embodiments, the first signaling includes uplink transmission assistance information. The uplink transmission assistance information may comprise at least one of:
an indication for a plurality of uplink data stream in one logical channel group (LCG)
an indication of a plurality of LCGs,
an indication of a plurality of physical uplink shared channel,
an indication of a plurality of HARQ process IDs,
offset information for a packet delay budget for a data stream.
time information of the communications of the plurality of data streams,
device type information associated with devices corresponding to the plurality of data streams, or
traffic type information associated with the plurality of data streams

In some embodiments, the indication for a plurality of uplink data stream in one LCG is configured to determine the synchronized data and the non-synchronized data.

In this embodiment, the uplink data stream with the indication is determined as synchronized data. The synchronized data refers to data which is (needed) to be synchronized.

In this embodiment, the uplink data stream with the indication is determined as non-synchronized data. The non-synchronized data refers to data which is not (needed) to be synchronized.

In some cases, the indication is a bit flag, where the bit ‘1’ denotes the uplink data stream is the synchronized data, while bit ‘0’ denotes the uplink data stream is the non-synchronized data.

In some cases, the indication is a codepoint, where the codepoint 1 denotes the uplink data stream is the synchronized data, while the codepoint 2 denotes the uplink data stream is the non-synchronized data

In some embodiments, the indication of a plurality of LCGs is configured to determine an association of a plurality of logical channel groups (LCGs).

In this embodiment, the association of the plurality of LCGs includes synchronizing data in the plurality of LCGs.

In some cases, the LCGs with the same indication are correlated LCGs, where the data in the correlated LCGs needs to be synchronized.

As an alternative, the indication of a plurality of LCGs is a bitmap indicating the correlation of LCGs, where LCGs indicated bit ‘1’ are the correlated LCG.

For example, 8 LCGs LCG1 to LCG8, the bitmap is 8-bit length and each bit sequentially corresponds to LCG1 to LCG8. For example, a bitmap ‘00100100’ means that the LCG5 and LCG2 are correlated. In other words, the data in LCG5 and that in LCG2 need to be synchronized.

As an alternative, the indication of a plurality of LCGs is a bit string indicating a group identifier of the plurality of LCGs, where the data in the LCGs indicated by the same group identifier is to be synchronized.

For example, data stream(s) in LCG 1 is indicated by a group identifier 1, while data stream(s) in LCG 2 is indicated by the group identifier 1. In this embodiment, the data streams in the LCG1 and the LCG2 need to be synchronized. In addition, data stream(s) in LCG 3 is indicated by a group identifier 2 and data stream(s) in LCG 4 is indicated also by the group identifier 2. The data streams in the LCG3 and the LCG4 need to be synchronized.

In an embodiment, the data stream in its logical channel indicated by an indication of a plurality of LCGs or an indication for a plurality of uplink data stream in one LCG needed to be synchronized is scheduled based on or by following pre-defined rule.

In an embodiment, the pre-defined rule includes at least one of:
the data in the logical channels within the LCGs needed to be synchronized is scheduled simultaneously; or
the data in the logical channels within the LCGs needed to be synchronized is scheduled with the restriction based on the synchronization requirement in the synchronization information.

In some embodiments, the logical channels in the LCGs needed to be synchronization comprise at least one of:
the same logical channel priority;
the same prioritized bit rate; or
the same bucket size duration.

In some embodiments, the first signaling is at least one of:
UE capability;
UE assistance information;
Media access control (MAC) control element (CE) signaling, or
Uplink control information (UCI) signaling.

In an embodiment of the first signaling being the MAC CE signaling, the first signaling includes a downlink transmission assistance information, and the MAC CE signaling is a buffer size reporting (BSR).

In this embodiment, the downlink transmission assistance information is in a dedicated Oct (octet) in a short BSR.

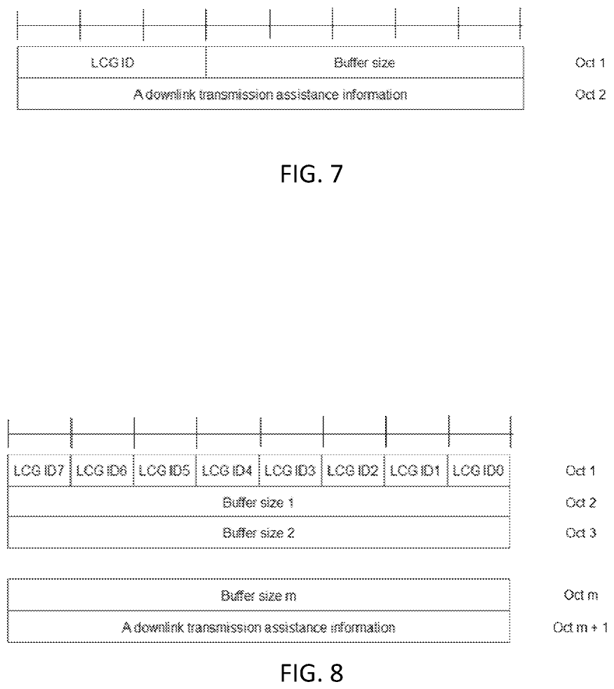

FIG. 7 shows a schematic diagram of a short BSR according to an embodiment of the present disclosure. In FIG. 7, the downlink transmission assistance information is in the October 2 in the short BSR.

In an embodiment, the downlink transmission assistance information is in a dedicated Oct in a long BSR.

FIG. 8 shows a schematic diagram of a long BSR according to an embodiment of the present disclosure. In FIG. 8, the downlink transmission assistance information is in the Oct m+1 in the long BSR.

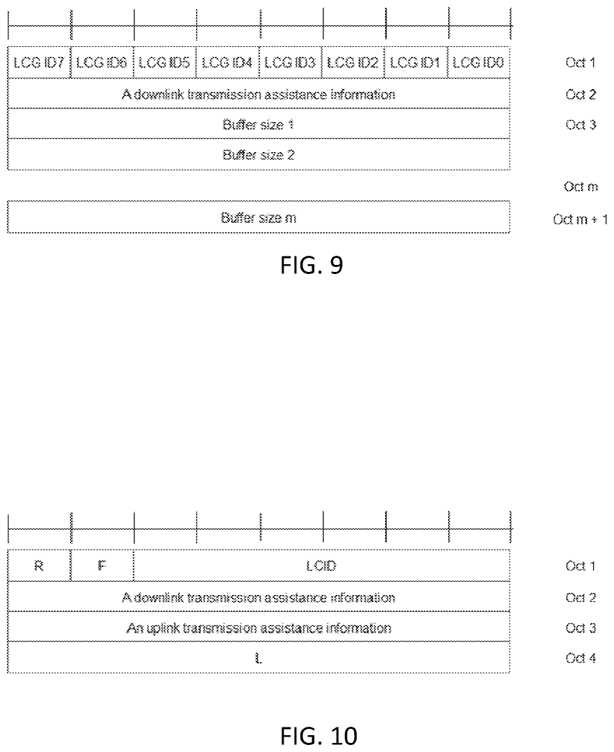

FIG. 9 shows a schematic diagram of a long BSR according to an embodiment of the present disclosure. In FIG. 9, the downlink transmission assistance information is in the October 2 in the long BSR.

In some embodiments, the downlink transmission assistance information is in the dedicated Oct in Extended (truncated) short BSR.

In some embodiments, the downlink transmission assistance information is in the dedicated Oct in Extended (truncated) long BSR.

In some embodiments, the downlink transmission assistance information is in the dedicated Oct in Extended (truncated) pre-emptive BSR.

In the embodiment of the first signaling being the BSR and comprising the downlink transmission assistance information, the BSR is a first BSR indicated by a logical channel identifier (LCID) or an enhanced logical channel identifier (eLCID).

In some embodiments, the first signaling includes the uplink transmission assistance information, and the MAC CE signaling is a buffer size reporting (BSR).

In some embodiments, the uplink transmission assistance information is in a dedicated Oct in the short BSR. In an embodiment, the location of the uplink transmission assistance information in the short BSR is similar to that of the downlink transmission assistance information in FIG. 7.

In some embodiments, the uplink transmission assistance information is in a dedicated Oct in the long BSR. In an embodiment, the location of the uplink transmission assistance information in the long BSR is similar to that of the downlink transmission assistance information in FIG. 8 or FIG. 9.

In some embodiments, the uplink transmission assistance information is in a dedicated Oct in Extended (truncated) short BSR.

In some embodiments, the uplink transmission assistance information is in a dedicated Oct in Extended (truncated) long BSR.

In some embodiments, the uplink transmission assistance information is in a dedicated Oct in Extend (truncated) pre-emptive BSR.

In the embodiment of the first signaling being the BSR and comprising the uplink transmission assistance information, the BSR is a second BSR indicated by a LCID or eLCID. That is the first BSR comprising the downlink transmission assistance information may be the same with or different from the second BSR comprising the uplink transmission assistance information.

In some embodiments, the downlink transmission assistance information and/or the uplink transmission assistance information is transmitted by a MAC subheader.

In an embodiment, the uplink transmission assistance information is in the R field in MAC subheader.

In an embodiment, the downlink and/or uplink transmission assistance information is in the dedicated field in MAC subheader.

FIG. 10 shows a schematic diagram of a MAC subheader according to an embodiment of the present disclosure. The MAC subheader in FIG. 10 is shown with only LCID. In FIG. 10, the downlink transmission assistance information is in the October 2 in the MAC subheader and the uplink transmission assistance information is in the October 3 in the MAC subheader.

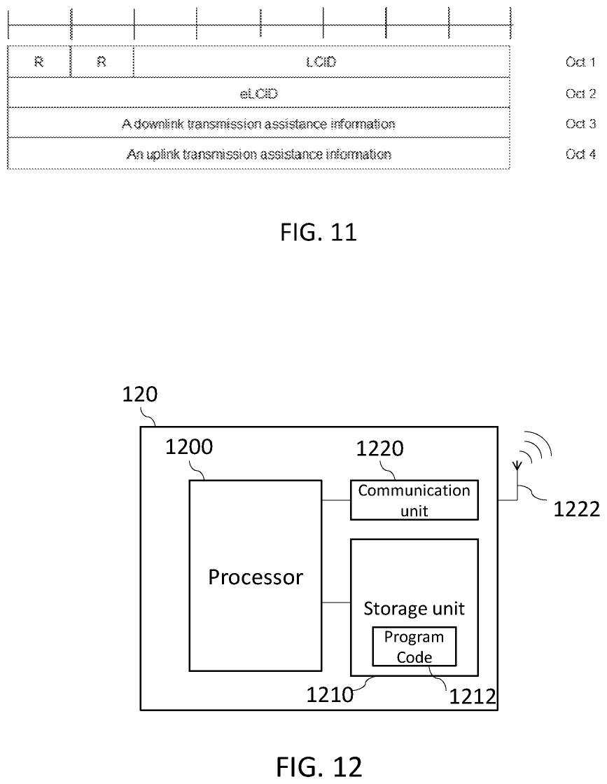

FIG. 11 shows a schematic diagram of a MAC subheader according to an embodiment of the present disclosure. The MAC subheader in FIG. 11 is shown with both the LCID and the eLCID. In FIG. 11, the downlink transmission assistance information is in the October 3 in the MAC subheader and the uplink transmission assistance information is in the October 4 in the MAC subheader, which are both behind the indication of eLCID.

In some embodiments, the UCI signaling is a signaling for resource release.

In some embodiments, the UCI signaling is a signaling for HARQ ACK (hybrid automatic repeat request acknowledgement).

In some embodiments, the UCI signaling is a signaling for a CSI (channel state information) report.

In some embodiments, a dedicated field in UCI signaling indicates the downlink transmission assistance information.

FIG. 12 relates to a schematic diagram of a wireless terminal 120 according to an embodiment of the present disclosure. The wireless terminal 120 may be a user equipment (UE), a mobile phone, a laptop, a tablet computer, an electronic book or a portable computer system and is not limited herein. The wireless terminal 120 may include a processor 1200 such as a microprocessor or Application Specific Integrated Circuit (ASIC), a storage unit 1210 and a communication unit 1220. The storage unit 1210 may be any data storage device that stores a program code 1212, which is accessed and executed by the processor 1200. Embodiments of the storage unit 1210 include but are not limited to a subscriber identity module (SIM), read-only memory (ROM), flash memory, random-access memory (RAM), hard-disk, and optical data storage device. The communication unit 1220 may a transceiver and is used to transmit and receive signals (e.g., messages or packets) according to processing results of the processor 1200. In an embodiment, the communication unit 1220 transmits and receives the signals via at least one antenna 1222 shown in FIG. 12.

In an embodiment, the storage unit 1210 and the program code 1212 may be omitted and the processor 1200 may include a storage unit with stored program code.

The processor 1200 may implement any one of the steps in exemplified embodiments on the wireless terminal 120, e.g., by executing the program code 1212.

The communication unit 1220 may be a transceiver. The communication unit 1220 may as an alternative or in addition be combining a transmitting unit and a receiving unit configured to transmit and to receive, respectively, signals to and from a wireless network node (e.g., a base station).

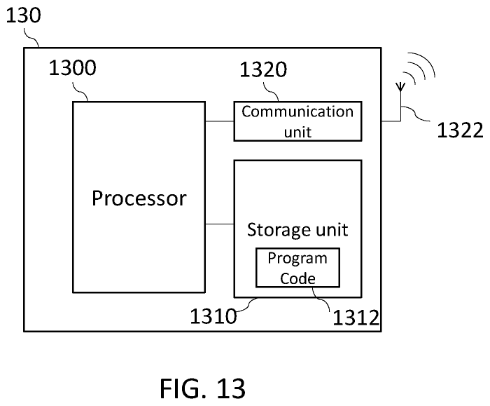

FIG. 13 relates to a schematic diagram of a wireless network node 130 according to an embodiment of the present disclosure. The wireless network node 130 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 130 may comprise (perform) at least one network function such as an access and mobility management function (AMF), a session management function (SMF), a user place function (UPF), a policy control function (PCF), an application function (AF), etc. The wireless network node 130 may include a processor 1300 such as a microprocessor or ASIC, a storage unit 1310 and a communication unit 1320. The storage unit 1310 may be any data storage device that stores a program code 1312, which is accessed and executed by the processor 1300. Examples of the storage unit 1310 include but are not limited to a SIM, ROM, flash memory, RAM, hard-disk, and optical data storage device. The communication unit 1320 may be a transceiver and is used to transmit and receive signals (e.g., messages or packets) according to processing results of the processor 1300. In an example, the communication unit 1320 transmits and receives the signals via at least one antenna 1322 shown in FIG. 13.

In an embodiment, the storage unit 1310 and the program code 1312 may be omitted. The processor 1300 may include a storage unit with stored program code.

The processor 1300 may implement any steps described in exemplified embodiments on the wireless network node 130, e.g., via executing the program code 1312.

The communication unit 1320 may be a transceiver. The communication unit 1320 may as an alternative or in addition be combining a transmitting unit and a receiving unit configured to transmit and to receive, respectively, signals to and from a wireless terminal (e.g., a user equipment or another wireless network node).

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a first node, the method comprising:
receiving, from a second node, a configuration signaling which comprises a configuration information associated with synchronizing a plurality of data streams.

2. The wireless communication method of claim 1, further comprising:
performing communications of the plurality of data streams based on the configuration information.

3. The wireless communication method of claim 1, wherein
synchronizing the plurality of data streams comprises at least one of:
processing the plurality of data streams synchronously,
scheduling the plurality of data streams synchronously,
grouping a plurality of devices associated with the plurality of data streams,
jointly processing the plurality of data streams,
jointly indicating the plurality of data streams, or
transmitting, to the second node, assistance information associated with the synchronization;
preferably, the configuration signaling comprises at least one of, a radio resource control signaling, a user equipment capability, a media access control (MAC) control element (CE) signaling, or a downlink control information signaling;
preferably, the configuration information comprises a synchronization indication for the plurality of data streams;
preferably, the first node is a user device and the second node is a network node.

4. (canceled)

5. The wireless communication method of claim 1, wherein the configuration information comprises at least one of a device cluster indication for a plurality of devices associated with the plurality of data streams or a synchronization indication of synchronizing the plurality of data streams.

6. The wireless communication method of claim 5, wherein the device cluster indication comprises at least one of:
a QoS parameter for the plurality of data streams,
device cluster information associated with a device cluster corresponding to the plurality of data streams, or
the synchronization indication of synchronizing the plurality of data streams.

7. The wireless communication method of claim 6, wherein the device cluster information comprises an association device identifier for a set of device identifiers of devices or a device cluster identifier.

8. The wireless communication method of claim 5, wherein the synchronization indication is determined by
a synchronization QoS parameter set,
a synchronization QoS parameter,
a synchronization QoS flow,
a radio bearer for the plurality of data streams,
a PDU session which comprises at least one radio bearer comprising QoS flows of the data streams to be synchronized,
a GTP header of the synchronization,
a PDU set importance indication for the plurality of data streams,
a predefined radio bearer, or
a predefined PDU session.

9. The wireless communication method of claim 8, wherein the synchronization QoS parameter set comprises at least one of:
a minimum packet delay budget within packet delay budgets of the data streams,
a maximum packet delay budget within the packet delay budgets of the data streams,
an average packet delay budget of the packet delay budgets of the data streams,
an offset for the packet delay budgets of the data streams,
a reference packet delay budget within the packet delay budgets of the data streams,
a time interval of synchronizing the plurality of data streams,
a common packet delay budget for each data stream, or
a synchronized level.

10-21. (canceled)

22. The wireless communication method of claim 8, wherein the PDU set importance indication comprises at least one of:
a PDU set importance level for the plurality of data streams,
a synchronization request indication for synchronizing the plurality of data streams, or
a QoS parameter set for synchronizing the plurality of data streams.

23. The wireless communication method of claim 1, wherein the first node is a network node and the second node is a core network node.

24-28. (canceled)

29. A wireless communication method for use in a second node, the method comprising:
transmitting, to a first node, a configuration signaling which comprises a configuration information associated with synchronizing a plurality of data streams.

30. The wireless communication method of claim 29, further comprising:
performing communications of the plurality of data streams based on the configuration information;
preferably, synchronizing the plurality of data streams comprises at least one of:
processing the plurality of data streams synchronously,
scheduling the plurality of data streams synchronously,
grouping a plurality of devices associated with the plurality of data streams,
jointly processing the plurality of data streams,
jointly indicating the plurality of data streams, or
transmitting, to the second node, assistance information associated with the synchronization;
preferably, the configuration information comprises at least one of a device cluster indication for a plurality of devices associated with the plurality of data streams or a synchronization indication of synchronizing the plurality of data streams;
preferably, the device cluster indication comprises at least one of:
a QoS parameter for the plurality of data streams,
device cluster information associated with a device cluster corresponding to the plurality of data streams, or
the synchronization indication of synchronizing the plurality of data streams;
preferably, the device cluster information comprises an association device identifier for a set of device identifiers of devices or a device cluster identifier;
preferably, the synchronization indication is determined by
a synchronization QoS parameter set,
a synchronization QoS parameter,
a synchronization QoS flow,
a radio bearer for the plurality of data streams,
a PDU session which comprises at least one radio bearer comprising QoS flows of
the data streams to be synchronized,
a GTP header of the synchronization,
a PDU set importance indication for the plurality of data streams,
a predefined radio bearer, or
a predefined PDU session;
preferably, the synchronization QoS parameter set comprises at least one of:
a minimum packet delay budget within packet delay budgets of the data streams,
a maximum packet delay budget within the packet delay budgets of the data streams,
an average packet delay budget of the packet delay budgets of the data streams,
an offset for the packet delay budgets of the data streams,
a reference packet delay budget within the packet delay budgets of the data streams,
a time interval of synchronizing the plurality of data streams,
a common packet delay budget for each data stream, or
a synchronized level;
preferably, the PDU set importance indication comprises at least one of:
a PDU set importance level for the plurality of data streams,
a synchronization request indication for synchronizing the plurality of data streams, or
a QoS parameter set for synchronizing the plurality of data streams;
preferably, the first node is a network node and the second node is a core network node;
preferably, the configuration signaling comprises at least one of, a radio resource control signaling, a user equipment capability, a media access control (MAC) control element (CE) signaling, or a downlink control information signaling;
preferably, the configuration information comprises a synchronization indication for the plurality of data streams;
preferably, the first node is a user device and the second node is a network node.

31-56. (canceled)

57. A wireless communication method for use in a first node, the method comprising:
transmitting, to a second node, a first signaling associated with configuration information associated with synchronizing a plurality of data streams.

58. The wireless communication method of claim 57, wherein the first signaling comprises downlink transmission assistance information comprising at least one of:
offset information for a packet delay budget,
time information of the communications of the plurality of data streams,
device type information associated with devices corresponding to the plurality of data streams, or
traffic type information associated with the plurality of data streams;
preferably, the offset information comprises at least one of: an offset of amending the packet delay budget, or a synchronizing margin for packet delay budget;
preferably, the time information comprises slot indexes, transmission time interval indexes or time stamp associated with the communications of the plurality of data streams;
preferably, the first signaling comprises uplink transmission assistance information including at least one of:
an indication for a plurality of uplink data streams in one logical channel group (LCG),
an indication of a plurality of LCGs,
an indication of a plurality of physical uplink shared channels,
an indication of a plurality of HARQ process IDs,
offset information for a packet delay budget,
time information of the communications of the plurality of data streams,
device type information associated with devices corresponding to the plurality of data streams, or
traffic type information associated with the plurality of data streams;
preferably, the first signaling comprises at least one of:
UE capability,
UE assistance information,
a MAC CE signaling, or
an uplink control information signaling;
preferably, the MAC CE signaling is a buffer size report (BSR), and
wherein information comprised in the first signaling is in a dedicated octet of the BSR;
preferably, wherein the first signaling comprises the MAC CE signaling, and
wherein downlink transmission assistance information and/or uplink transmission assistance information comprised in the first signaling is in a MAC sub-header of the MAC CE signaling;
preferably, the uplink control information signaling comprises at least one of an uplink control information for resource release, or HARQ ACK information or a channel state information;
preferably, the first node is a user device and the second node is a network node.

59-76. (canceled)

77. A first node, comprising: a processor configured to perform the wireless communication method of claim 1.

78. (canceled)

79. A second node, comprising: a processor configured to perform the wireless communication method of claim 29.

80. (canceled)

81. A first node, comprising: a processor configured to perform the wireless communication method of claim 57.

82-84. (canceled)

85. A computer program product comprising a computer-readable program medium code stored thereupon, the code, when executed by a processor, causing the processor to implement a wireless communication method recited in claim 1.

86. A computer program product comprising a computer-readable program medium code stored thereupon, the code, when executed by a processor, causing the processor to implement a wireless communication method recited in claim 29.

87. A computer program product comprising a computer-readable program medium code stored thereupon, the code, when executed by a processor, causing the processor to implement a wireless communication method recited in claim 57.
